(19) United States
(12) Patent Application Publication
(10) Pub. No.: US 2010/0119664 A1
(43) Pub. Date: May 13, 2010

(54) CONFECTIONERY PRODUCTS COMPRISING POLYOLS

(75) Inventor: Barbara Stawski, Forest Park, IL (US)

Correspondence Address: K&L Gates LLP, P.O. Box 1135, CHICAGO, IL, 60690, US

(73) Assignee: WM. WRIGLEY JR. COMPANY, Chicago, IL (US)

(21) Appl. No.: 12/526,916

(22) PCT Filed: Feb. 11, 2008
(86) PCT No.: PCT/US08/53582

§ 371 Date: Jan. 25, 2010

Related U.S. Application Data
(60) Provisional application No. 60/889,440, filed on Feb. 12, 2007.

(51) Int. Cl. A23G 3/42; A23G 3/36; A23G 3/54

(52) U.S. Cl. 426/103; 426/573; 426/576; 426/577; 426/575; 426/578; 426/548

(57) ABSTRACT

Confectionery products comprising erythritol and methods of producing the confectionery products are provided. In a general embodiment, the present disclosure provides a jelly confectionery product comprising erythritol, a jellying agent and a gastrointestinal tolerant ingredient.

### BACKGROUND

The present disclosure relates generally to confectionery products. More specifically, the present disclosure relates to jelly confectionery products comprising erythritol.

There are numerous types of confectionery products. Such confectionery products can include, for instance, hard or chewy candy. It is generally known that providing confectionery products having unique flavors and health benefits can lead to enhanced marketability with consumers. Jelly beans are a common sugar-based jellied confectionery. Manufacturers have attempted to produce jellied products with less sugar, but the polyols commonly used can create gastrointestinal distress. For example, some sugarless candies comprising polyols such as isomalt and sorbitol have a laxative effect.

### SUMMARY OF THE INVENTION

The present disclosure is directed to confectionery products comprising erythritol and methods of producing these confectionery products. In a general embodiment, the present disclosure provides a jelly confectionery product comprising erythritol and a jellying agent. In another embodiment, the present disclosure provides a jelly confectionery product comprising erythritol, a jellying agent and a gastrointestinal tolerant ingredient.

In an embodiment, the erythritol comprises from about 1% to about 70% by total weight of the confectionery product.

In an embodiment, the gastrointestinal tolerant ingredient comprises from about 30% to about 80% by total weight of the confectionery product.

In an embodiment, the gastrointestinal tolerant ingredient comprises polydextrose.

In an embodiment, the gastrointestinal tolerant ingredient comprises a dextrin (e.g. indigestible dextrin).

In an embodiment, the gastrointestinal tolerant ingredient comprises inulin, fructooligosaccharide, carboxymethyl cellulose, microcrystalline cellulose or combinations thereof.

In an embodiment, the jellying agent can be, for example, gelatin, gellan gum, xanthan gum, pectin, carrageenan, cellulose gum, gum arabic, modified starch or combinations thereof.

In an embodiment, the confectionery product comprises another polyol such as, for example, sorbitol, maltitol, isomalt, mannitol, xylitol or combinations thereof. The polyols can be in any suitable form such as, for example, powders or syrups.

In an embodiment, the polyol comprises from about 1% to about 25% by total weight of the confectionery product.

In an embodiment, the confectionery product comprises one or more ingredients such as, for example, malted products, sweeteners, flavors, colors, sensates, acids, medicaments, actives or combinations thereof.

In an embodiment, the confectionery product comprises a coating surrounding the jelly confectionery product.

In an embodiment, the coating comprises one or more ingredients such as, for example, malted products, sweeteners, flavors, colors, sensates, acids, medicaments, actives or combinations thereof.

In an embodiment, the jelly confectionery product comprises a center-filling.

In an embodiment, the center-filling can be a powder, a liquid or combinations thereof.

In another embodiment, the present disclosure provides a method of making a jelly confectionery product. The method comprises preparing a jelly candy mixture comprising erythritol, a jellying agent and a gastrointestinal tolerant ingredient, and forming the jelly candy mixture to produce the jelly confectionery product.

In an embodiment, the method further comprises applying a coating to the formed jelly confectionery product.

In an embodiment, the coating comprises erythritol.

An advantage of the present disclosure is to provide an improved confectionery product providing health benefits.

Yet another advantage of the present disclosure is to provide an improved process for making confectionery products.

Additional features and advantages are described herein, and will be apparent from, the following Detailed Description.

### DETAILED DESCRIPTION

The present disclosure relates to jelly confectionery products comprising erythritol and methods for producing the confectionery products. Erythritol does not cause tooth decay, and is absorbed by the body, therefore unlikely to cause gastric side effects unlike other sugarless sweeteners. Nevertheless, due to its high tendency to crystallize, erythritol tends to make a grainy product unless its crystallization is moderated or inhibited. Accordingly, the present disclosure provides confectionery products comprising erythritol and gastrointestinal tolerant ingredients that can also inhibit crystallization.

In a general embodiment, the present disclosure provides a jelly confectionery product comprising erythritol and one or more jellying agents. As used herein, the term “jelly confectionery product” means that the confectionery product comprises a hydrocolloid or gel-based confectionery that is free of fat as understood by the skilled artisan. The jellying agent is a hydrocolloid or gel-based ingredient such as, for example, for example, gelatin, gellan gum, xanthan gum, pectin, carrageenan, cellulose gum, gum arabic, modified starch or combinations thereof. In an embodiment, the jellying agent can comprise from about 1% to about 20% by total weight of the confectionery product. In an alternative embodiment, the jellying agent can comprise from about 5% to about 10% by total weight of the confectionery product.

In an embodiment, the erythritol can comprise from about 1% to about 70% by total weight of the confectionery product. In another embodiment, the erythritol can comprise from about 5% to about 20% by total weight of the confectionery product. In yet another embodiment, the erythritol can comprise from about 20% to about 60% by total weight of the confectionery product. In an alternative embodiment, the erythritol can comprise from about 40% to about 50% by total weight of the confectionery product.

In another embodiment, the present disclosure provides a jelly confectionery product comprising erythritol, one or more jellying agents and one or more gastrointestinal tolerant ingredients. The gastrointestinal tolerant ingredient can be any suitable ingredient that has a low or reduced laxation effect on a consumer's digestive system as understood by the skilled artisan.

In an embodiment, the gastrointestinal tolerant ingredient is polydextrose. In another embodiment, the gastrointestinal tolerant ingredient is dextrin (e.g. indigestible dextrins). The dextrins can be made from wheat or corn. Indigestible dextrins are modified maltodextrins with very low reducing sugar content. Varieties are sold under the trade names of FIBERSOL® and NUTRIOSE®. FIBERSOL® is marketed by Fibersol America, a division of Matsutani Chemical Industry Co., Ltd of Hyogo-Pref., Japan. NUTRIOSE® is marketed by Roquette Freres of Lestrem, France. In an alternative embodiment, the gastrointestinal tolerant ingredient is inulin, fructooligosaccharide, carboxymethyl cellulose, microcrystalline cellulose or combinations thereof.

In an embodiment, the gastrointestinal tolerant ingredient comprises from about 30% to about 80% by total weight of the confectionery product. In another embodiment, the gastrointestinal tolerant ingredient comprises from about 40% to about 70% by total weight of the confectionery product.

In an alternative embodiment, the confectionery product can comprise another polyol such as, for example, sorbitol, maltitol, isomalt, mannitol, xylitol or combinations thereof. The polyols can be in any suitable form such as, for example, powders or syrups. The polyol can comprise from about 1% to about 25% by total weight of the confectionery product.

In an embodiment, the confectionery product comprises a coating surrounding the jelly confectionery product. The coating can initially be present as a liquid syrup which contains from about 30% to about 80% or 85% of the suitable coating ingredients, and from about 15% or 20% to about 70% of a solvent such as water. The coating syrups of the present disclosure may comprise erythritol or other polyol or non-polyol ingredients which are commonly used in sugar and sugarless coatings. The specific ingredients and their usage levels will vary greatly according to the intentions for the formulation. The coatings can be dried, for example, to form as soft or hard coating as desired.

In another embodiment, the present disclosure provides a method of making a confectionery product. The method comprises preparing a jelly candy mixture comprising erythritol, a jellying agent and a gastrointestinal tolerant ingredient, and forming the jelly mixture into a finished confectionery product. For example, the jelly candy mixture can be formed by any suitable laminating, extruding or depositing processes. The jelly confectionery products in embodiments of the present disclosure can be formed into any suitable size or shape such as, for example, a pellet, sphere, cube, cigarette, spiral, etc. The confectionery products can have any suitable thickness.

In an embodiment, the method further comprises applying a coating to the formed jelly confectionery product. For example, the coating can comprise erythritol. In an embodiment, the erythritol may comprise from about 1% to about 70% by total weight of the confectionery product including the coating. In another embodiment, the erythritol can comprise from about 20% to about 60% by total weight of the confectionery product including the coating. In an alternative embodiment, the erythritol can comprise from about 40% to about 50% by total weight of the confectionery product including the coating.

Any suitable coating material (e.g. syrups) such as, for example, sugars, polyols or combinations thereof can be applied to the jelly confectionery product (e.g. confectionery center) to form a crystalline or glassy coating around the confectionery product. It should be appreciated that the coatings can be applied to the confectionery products by any suitable coating method such as, for example, spraying, panning, etc. Optionally, flavors may be separately sprayed onto the pieces during the coating process to provide a flavored coating. Optionally, a final polishing coat may be applied to the pieces after the coatings have been applied. The polishing coat may use a wax, such as carnauba wax, or shellac. It may also include fillers such as talc and colors.

In another embodiment, the jelly confectionery product can comprise a center-filling. For example, the center-filling can be a confectionery powder, confectionery liquid (e.g. syrup) or combinations thereof. The jelly confectionery products of the present disclosure can also include confectionery particles or nonpareils within them. As laminated, extruded or deposited, the viscosity of the confectionery products can be such that the particles are homogeneously or heterogeneously distributed through processing.

It should be appreciated that one or more ingredients such as malted products, flavors, sensates, colors (e.g. azo free colors), sweetener, acids, actives and medicaments (e.g. listed below) can go in the confectionery product and/or the coating surrounding the confectionery product. The ingredients can be added in a free form in any suitable amount. The ingredients can also be added in the form of encapsulation, compaction, granulation and agglomeration to provide, for example, protected and longer-lasting ingredient components such as flavors and sensates. It should also be appreciated that the jelly confectionery products and coatings can comprise any suitable number and combinations of the malted products, flavors, sweeteners (including high intensity), sensates, acids, actives and/or medicaments.

Sugar sweeteners generally may include saccharide-containing components commonly known in the confectionery art, including, but not limited to, sucrose, dextrose, maltose, dried invert sugar, fructose, levulose, tagatose, galactose, corn syrup solids, and the like, alone or in combination. Alternatively, sweeteners may include glycerin, fruit concentrates and fruit pastes.

Maltitol may be used as a sugarless sweetener. Additionally, sugarless sweeteners may include, but are not limited to, other sugar alcohols such as xylitol, sorbitol, erythritol, mannitol, isomalt, lactitol, hydrogenated starch hydrolysates, and the like, alone or in combination.

High intensity artificial or natural sweeteners may also be used in combination with the above. Preferred high intensity sweeteners include, but are not limited to sucralose, neotame, aspartame, salts of acesulfame, alitame, saccharin and its salts, cyclamic acid and its salts, stevioside, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener can vary greatly and will depend on such factors as potency of the sweetener, rate of release, desired sweetness of the product, level and type of flavor used and cost considerations.

The flavorant or flavor used in the confectionery products may include any natural or synthetic oil and/or flavor as is commonly known in the art. Natural and artificial flavoring agents may be combined in any sensorially acceptable fashion. The flavor agents can be used in any suitable amount in the confectionery products.

Nonlimiting examples of suitable flavorants include natural and synthetic flavoring agents chosen from synthetic flavor oils and flavoring aromatics, and/or oils, oleo resins and extracts derived from plants, leaves, flowers, fruits, vegetables and so forth, and combinations thereof. Nonlimiting examples of flavor oils include spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, and cassia oil. Also nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. Flavors may also include any suitable pastes, powders and extracts of fruits and/or vegetables. Alternatively, flavors types may salty, meaty, potato chip, etc.

It is understood that these flavorants may be used alone or in combination with or without a sensate such as, for example, a cooling or heating agent as is commonly known in the art. The flavorant or flavor may be encapsulated or non-encapsulated. Encapsulated flavorant may be used to increase or decrease the flavor release rate as is commonly known in the art.

Generally, sensates may be any compounds cause a cooling, heating, warming, tingling or numbing, for example, to the mouth or skin. Non-limiting examples of coolants include menthol substituted p-menthane carboxamides, acyclic carboxamides, menthone glycerol ketals, menthyl lactate, menthyl succinate, 3-1-menthoxypropane-1,2 diol, and spearmint. Non-limiting examples of heating agents may include vanillyl alcohol n-butyl ether, vanillyl alcohol n-propyl ether, vanillyl alcohol isopropyl ether, vanillyl alcohol isobutyl ether, vanillyl alcohol n-amino ether, vanillyl alcohol isoamyl ether, vanillyl alcohol n-hexyl ether, vanillyl alcohol methyl ether, vanillyl alcohol ethyl ether, gingerol, shogaol, paradol, zingerone, capsaicin, dihydrocapsaicin, nordihydrocapsaicin, homocapsaicin, homodihydrocapsaicin, ethanol, iso-propyl alcohol, iso-amylalcohol, benzyl alcohol, chloroform, eugenol, cinnamon oil, cinnamic aldehyde and phosphate derivatives of same. Non-limiting examples of tingling agents may include Jambu Oleoresin or para cress (Spilanthes sp.) (the active ingredient being spiranthol), Japanese pepper extract (Zanthoxylum peperitum) having the active ingredient(s) known as Saanshool-I, Saanshool-II and Sanshoamide, black pepper extract (Piper nigrum) (having the active ingredients chavicine and piperine), echinacea extract, northern prickly ash extract, red pepper oleoresin, and effervescing agents, such as edible acids and bases.

Generally, actives may include, inter alia, anti-oxidants, vitamins, minerals, stimulants, prebiotics, probiotics, enzymes, genetically modified organisms, nutritional supplements, yoghurt ingredients and whitening ingredients. Generally, medicaments may include, inter alia, analgesics, antibiotics, antivirals, antihistamines, anti-inflammatories, decongestants, antacids, muscle relaxants, psychotherapeutic agents, insulin, diuretics, anesthetics, antitussives, anti-diabetic agents, bioengineered pharmaceuticals, nutraceuticals, traditional medicines and cardiovascular agents. It is envisioned, that depending on the medicament, the resultant product can be used to treat, inter alia: coughs, colds, motion sickness, allergies, fevers, pain, inflammation, sore throats, cold sores, sinus problems, diarrhea, diabetics, gastritis, depression, anxiety, hypertension, angina, and other maladies and symptoms.

Specific actives may include, by way of example and not limitation: b-glucan, isoflavones, omega-3 fatty acid, lignans, lycopene, allicin, glucosinolates, limonoids, fructose and a nondialyzable polymeric compound, polyphenols, catechins (e.g. epigallocatechin-3-gallate, epigallocatechin, epicatechin-3-gallate, epicatechin), phenolics, polyunsaturated fatty acids (PUFAs such as omega-3 (n-3) fatty acids), soy protein, soy isolates, conjugated linoleic acid (CLA), caffeine, aspirin, nicotine, echinacea purpurea, ginseng, kola nut, capsicum, nettle, passion flower, St. Johns Wort, valerian, Ma Huang/guarana, kava kava and chamomile.

Vitamins may include Vitamins A, B-complex (such as B-1, B-2, B-6 and B-12), C, D, E and K, niacin and acid vitamins such as pantothenic acid and folic acid and biotin. Minerals may include calcium, iron, zinc, magnesium, iodine, copper, phosphorus, manganese, potassium, chromium, molybdenum, selenium, nickel, tin, silicon, vanadium and boron.

Specific medicaments may include, by way of example and not limitation: aspirin, acetaminophen, ibuprofen, ketoprofen, cimetodine, ranitidine, famotidine, dramamine, omeprazole, dyclonine, chlorpheniramine maleate, pseudoephedrine, hydrochloride, dextromethorphan hydrobromide, benzocanine, sodium naproxen, hydroxycitric acid, chromium picolinate, phosphatidylserine and insulin.

### EXAMPLES

By way of example and not limitation, the following examples are illustrative of various embodiments of the present disclosure.

### Example 1

### Jelly Candy Formulations

TABLE 1
Jelly Formulation A

| Jelly | | |
|---|---|---|
| Confectionery | Ingredients | Weight % |
| A | Polydextrose | 48 |
| | Erythritol | 4.66 |
| | Polyol | 23 |
| | High intensity sweetener #1 | 0.035 |
| B | Gelatin (250 bloom) | 8 |
| | Water | 12.33 |
| C | Calcium lactate | 2.4 |
| | High intensity sweetener #2 | 0.07 |
| D | Malic acid | 1.5 |
| | Flavors | as needed |

The ingredients in “A” are boiled to 114° C. “B” is dissolved at 70° C. After cooling “A” to a temperature of 100° C., “B” and “C” are added and slowly stirred together until a homogenous jelly mass is formed. “D” is added to the jelly mass and the mixture is allowed to cool to 55° C. The mixture is whipped in a mixing bowl for 1 minute and then deposited into a moulding starch. After 48 hours at room temperature, the moulded jelly products are removed and an anti-sticking agent is added as necessary.

TABLE 2
Jelly Formulation B

| Jelly | | |
|---|---|---|
| Confectionery | Ingredients | Weight % |
| A | Polydextrose | 76.77 |
| | Erythritol | 5.56 |
| | High intensity sweetener #1 | 0.05 |
| B | Gelatin (250 bloom) | 7.02 |
| | Water | 9 |
| C | High intensity sweetener #2 | 0.10 |
| D | Citric acid | 1.5 |
| | Flavors | as needed |

The ingredients in “A” are boiled to 114° C. “B” is dissolved at 70° C. After cooling “A” to a temperature of 100° C., “B” and “C” are added and slowly stirred together until a homogenous jelly mass is formed. “D” is added to the jelly mass and the mixture is allowed to cool to 55° C. The mixture is whipped in a mixing bowl for 1 minute and then deposited into a moulding starch. After 48 hours at room temperature, the moulded jelly products are removed and an anti-sticking agent is added as necessary.

TABLE 3
Jelly Formulation C

| Jelly | | |
|---|---|---|
| Confectionery | Ingredients | Weight % |
| A | Maltitol syrup | 68.94 |
| | Erythritol | 12.88 |
| | High intensity sweetener #1 | 0.04 |
| B | Gelatin (250 bloom) | 6.80 |
| | Water | 10.20 |
| C | High intensity sweetener #2 | 0.07 |
| D | Citric acid | 1.08 |
| | Flavors | as needed |

The ingredients in “A” are boiled to 87% solids. “B” is dissolved at 70° C. After cooling “A” to a temperature of 90° C., “B” and “C” are added and slowly stirred together until a homogenous jelly mass is formed. “D” is added to the jelly mass and the mixture is allowed to cool to 55° C. The mixture is whipped in a mixing bowl for 1 minute and then deposited into a moulding starch. After 48 hours at room temperature, the moulded jelly products are removed and an anti-sticking agent is added as necessary.

TABLE 4
Jelly Formulation D

| | Amount |
|---|---|
| Ingredients | (grams) |
| Sorbitol | 142.0 |
| Maltitol syrup | 118.5 |
| Erythritol | 100.0 |
| Ammonium chloride | 26.0 |
| Water | 337.0 |
| Gum arabic | 337.0 |
| Licorice paste | 92.30 |
| Flavor #1 | 10.0 |
| Flavor #2 | 5.0 |
| High intensity sweetener | 0.40 |
| Total | 2228.30 |

A gum arabic solution is made by dissolving the gum arabic in the water. The sorbitol, maltitol syrup and erythritol are mixed into the gum arabic solution. The salt (ammonium chloride) is added, and the mixture is cooked to approximately 130° C. to obtain a cooked mixture of having 74% dissolved solids. The licorice paste, flavors, sucralose and sweetener are the combined with the cooked mixed. The final mixture is deposited into a starch mold at 70% dissolve solids and formed into the final confectionery product.

TABLE 5
Jelly Formulation E

| | Amount |
|---|---|
| Ingredients | (grams) |
| Maltitol syrup | 473.3 |
| Erythritol | 100.0 |
| Gum arabic | 337.0 |
| Water | 337.0 |
| Flavor #1 | 6.00 |
| High intensity sweetener | 0.650 |
| Color | 1.10 |
| Flavor #2 | 2.70 |
| Total | 1257.75 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A jelly confectionery product comprising:
erythritol;
a jellying agent; and
a gastrointestinal tolerant ingredient.

2. The confectionery product of claim 1, wherein the erythritol comprises from about 1% to about 70% by total weight of the confectionery product.

3. The confectionery product of claim 1, wherein the gastrointestinal tolerant ingredient comprises from about 30% to about 80% by total weight of the confectionery product.

4. The confectionery product of claim 1, wherein the gastrointestinal tolerant ingredient comprises polydextrose.

5. (canceled)

6. The confectionery product of claim 1, wherein the gastrointestinal tolerant ingredient is selected from the group consisting of inulin, fructooligosaccharide, carboxymethyl cellulose, microcrystalline cellulose, dextrin and combinations thereof.

7. The confectionery product of claim 1, wherein the jellying agent is selected from the group consisting of gelatin, gellan gum, xanthan gum, pectin, carrageenan, cellulose gum, gum arabic, modified starch and combinations thereof.

8. The confectionery product of claim 1, further comprising a polyol selected from the group consisting of sorbitol, maltitol, isomalt, mannitol, xylitol and combinations thereof.

9. The confectionery product of claim 8, wherein the polyol comprises from about 1% to about 25% by total weight of the confectionery product.

10. The confectionery product of claim 1, wherein the jelly confectionery product comprises at least one ingredient selected from the group consisting of malted products, sweeteners, flavors, colors, sensates, acids, medicaments, actives and combinations thereof.

11. The confectionery product of claim 1 further comprising a coating surrounding the jelly confectionery product.

12. The confectionery product of claim 1, wherein the coating comprises at least one ingredient selected from the group consisting of malted products, sweeteners, flavors, colors, sensates, acids, medicaments, actives and combinations thereof.

13. The confectionery product of claim 1, wherein the jelly confectionery product comprises a center-filling.

14. The confectionery product of claim 13, wherein center-filling is selected from the group consisting of a powder, a liquid and combinations thereof.

15. A method of making a jelly confectionery product, the method comprising:
preparing a jelly candy mixture comprising erythritol, a jellying agent and a gastrointestinal tolerant ingredient; and
forming the jelly candy mixture to produce the jelly confectionery product.

16. The method of claim 15, wherein the erythritol comprises from about 1% to about 70% by total weight of the jelly confectionery product.

17. The method of claim 15, wherein the gastrointestinal tolerant ingredient comprises from about 30% to about 80% by total weight of the method.

18. The method of claim 15, wherein the gastrointestinal tolerant ingredient comprises polydextrose.

19. (canceled)

20. The confectionery product of claim 15, wherein the gastrointestinal tolerant ingredient is selected from the group consisting of inulin, fructooligosaccharide, carboxymethyl cellulose, microcrystalline cellulose, dextrin and combinations thereof.

21. The method of claim 15, further comprising applying a coating to the formed jelly confectionery product.

22. The method of claim 21, wherein the coating comprises erythritol.
